(19) United States
(12) Patent Application Publication
(10) Pub. No.: US 2011/0305499 A1
(43) Pub. Date: Dec. 15, 2011

(54) RING BINDER MECHANISM WITH HOLE PUNCH ASSEMBLY

(76) Inventor: Jason Lorenzen, Prior Lake, MN (US)

(21) Appl. No.: 13/156,217

(22) Filed: Jun. 8, 2011

Related U.S. Application Data
(60) Provisional application No. 61/397,337, filed on Jun. 10, 2010.

(51) Int. Cl. B42F 13/40

(52) U.S. Cl. 402/1

(57) ABSTRACT

A ring binder mechanism having hole-punch assembly integrated therewith such as to conserve space and not impede the normal operation when disposed within a binder or a notebook. A novel aspect of the present invention allows the user to consolidate paper alignment, hole-punch capability and ring or loop binding functions into one portable storage assembly, thereby reaping the benefit of a convenient, effective, reliable and immediate paper storage apparatus in a portable form factor.

### CROSS REFERENCE TO RELATED APPLICATIONS

This application claims priority to and the benefit of the provisional application having Ser. No. 61/397,337 and filed on Jun. 10, 2010. The provisional application is herein incorporated by reference in its entirety.

### FIELD OF THE INVENTION

The present invention relates generally to the field of stationery supplies, and more specifically to single and multiple-ring binder notebooks and binders.

### BACKGROUND OF THE INVENTION

The multiple-ring binder has long been the preferred storage medium for paper and other artifacts. Previously, the collection of papers or documents in hardcopy secured format (as opposed to a manila folder, for example) required a minimum of two separate products: a multiple-ring binder and a separate paper hole-punch; the latter, often not being readily available when needed in remote locations such as the classroom or conference rooms, etc. areas that are away from home or the office. In addition, most documents in paper (or photographic) form do not have pre-punched holes to accommodate the multiple-ring binder. It would be desirable to be able to securely bind and/or file paper documents and store such paper artifacts in a portable device while temporarily at a remote location.

The typical multiple-hole paper punch device is generally heavy and too large for portability. On the other hand, the single-hole punch (pliers-type) device is easily portable but lacks the accuracy in aligning the holes on the paper or item to be filed with the ringed notebook or binder. The alternative of not securing loose papers or artifacts while away from home or the office is also not desirable in that it is extremely inconvenient and often results in lost or damaged paper or other valuable artifacts. These and other challenges are addressed by the various embodiments of the present invention.

### SUMMARY OF THE INVENTION

The present invention relates generally to a ringed or looped binder assembly or frame having hole-punch mechanism or assembly integrated therewith such as to conserve space and not impede the normal operation of the binder or notebook. A novel aspect of the present invention allows the user to consolidate paper alignment, hole-punch capability and ring or loop binding functions into one portable storage assembly, thereby reaping the benefit of a convenient, effective, reliable and immediate paper storage apparatus in a portable form factor.

In one example embodiment of a ring binder mechanism with holepunch assembly there is included a first elongate plate having a top and a bottom surface and a plurality of ring members disposed on the top surface of the first elongate plate, the ring members configured to be opened and closed. The ring binder mechanism further includes a plurality of projection members disposed on the bottom surface of the first elongate plate and a second elongate plate coupled to a portion of the first elongate plate so as to form a hinge therebetween. The second plate is configured to have a plurality of holes configured to be aligned with the plurality of projection members in a mating relationship thereby forming the holepunch assembly. In a related embodiment, the ring members are configurable to open or closed individually or together via a binder carriage assembly that uses a binder tab and a spring loaded assembly to open and close simultaneously the ring members. In yet another related embodiment, the second plate or base plate is configurable to fasten or secure (either temporarily or permanently) the ring binder mechanism to a binder or a notebook. In yet another related embodiment, the second plate is configurable to accommodate a removable (or permanent) tray or housing to collect the hole punches. In yet another embodiment, the second plate forms part of a housing for collecting hole punches and includes a flap or slide door to allowing emptying of the hole punches.

In another example embodiment of a ring binder mechanism with holepunch assembly there is included a first elongate plate having a top and a bottom surface and at least one ring member disposed on the top surface of the first elongate plate, the at least one ring member configured to be opened and closed. In addition, at least one projection member is disposed on the bottom surface of the first elongate plate while a second elongate plate having at least one hole therethrough is configured to receive the at least one projection member therethrough, wherein the first plate and the second plate are configured to be joined via the projection member and the aperture to form the holepunch assembly. In a related embodiment, the first and second plates are joined at one edge to form a hinge therebetween to facilitate the holepunch function. In yet another related embodiment, the single ring member of the ring binder mechanism is individually opened and closed to be able to receive a hole-punched sheet of paper.

In yet another related embodiment the entire ring binder mechanism is moldable from plastic (or other flexible material) such that a first plate and a second plate are configured from a single piece of material with the hinge being formed therebetween from the same piece of material. The single piece of plastic material further includes the plurality of projections molded on the first plate with the plurality of ring members being formed from plastic strand members located on a top edge of the first plate having a T-shaped or sphere termination. In addition, the second plate has the plurality of holes punched therethrough for receiving the projections. The first plate further includes holes to receive the molded plastic strand member ends which will form the ring members once the ring binder mechanism is assembled.

Advantageously, the various embodiments of the present invention provide for no adverse format, size or weight impact to the standard multiple-ring (or single loop or clamp) binding configuration while meeting the requirements for portability and convenience. The ringed hole-punch assembly of the present invention is conveniently relatively flat, so that it does not significantly affect the number of sheets that will be stored in the multiple-ring binder notebook or folder. The low profile assembly also ensures that the multiple-ring assembly will close properly and remain so. In a related embodiment, a single clasp or clamp can be added for additional security in closure. In yet another related embodiment, one or more projection members in the closed position serve as a clamping function to help a ring assembly with one or more rings to remain closed.

In another aspect of the present invention, the ring binder mechanism is self-aligned preferably in the same manner as the sheets therein, namely, thereby providing appropriate spacing to accommodate the multiple-ring configuration of the multiple-ring binder. In a related embodiment, the ring binder mechanism is easily configured to accommodate a single ring and associated hole and hole-punch.

In yet another aspect of the present invention the ring binder mechanism is light so that it does not add significantly to the weight of the multiple-ring binder and the overall burden to the user who may carry several such binders and materials enroute to the office or schoolroom. Further, the ring binder mechanism is easy to use in terms of additional time or energy to align, punch and insert one or more sheets of paper into the ring binder assembly. The configuration of the “ring” includes but is not limited to various geometric shapes that permit open and closure such as ovals, rectangles, squares, and circles as were two ends come together for closure. In a related embodiment, the ring or rings are shaped in an “easy-grip” fashion to include at the top of the ring at least 2 curved halves connecting up at the middle to improve gripping of the ring(s) during a hole punching operation.

In a related aspect of the invention, the “ring” of the ring binder assembly mechanism is a single ring member that is opened/closed via an additional lever, such as in a spring-loaded C-clip, so as to have a single ring that pivots the hole punch portion thereby facilitating paper collection at one corner of the stack of papers to be held together. In a related embodiment, the ring member has an opening that is closed or “joined” via one member (or two opposing but complementary members) in a screw-lock configuration (or SurLock screw configuration). In another embodiment, an “easy grip” ring style allows a more ergonomic feel to enhance ring open and closing actuation. In yet another related embodiment, one or more of these ring members are combined to hole-punch and hold the paper stack without the additional cost of using the spring-loaded assembly that controls all of the ring members at once from either end of the ring binder mechanism.

### BRIEF DESCRIPTION OF THE DRAWINGS

FIG. 1 is a perspective, exploded view of an embodiment of a ring binder mechanism and hole-punch assembly with optional removable tray member according to the present invention.

FIG. 2 is a side view of the ring binder mechanism of FIG. 1 as part of a notebook or binder according to the present invention.

FIGS. 3A and 3B are open and closed perspective views of the binder mechanism opening lengthwise along a hinged binder frame illustrating the hole-punch assembly.

FIG. 3C is an exploded, perspective view of the binder mechanism of FIG. 4.

FIGS. 4A and 4B are side views of the ring member and hole-punch assembly unit and a separated hole-punch assembly according to the present invention.

FIGS. 5A-5C are perspective, side and end views of another embodiment of the binder mechanism of the present invention using a single end hinged configuration.

FIGS. 6A and 6B are side views of other embodiments of a binder mechanism with hole-punch capabilities of the present invention using different closure mechanisms.

FIG. 7 is a perspective view of another ring design according to the present invention.

FIGS. 8A and 8B are side views of another embodiment of the binder mechanism of the present invention.

The same elements or parts throughout the figures of the drawings are designated by the same reference characters.

### DETAILED DESCRIPTION OF THE PREFERRED EMBODIMENTS

The following description is meant to be illustrative only and not limiting. Other embodiments of this invention will be apparent to those of ordinary skill in the art in view of this description.

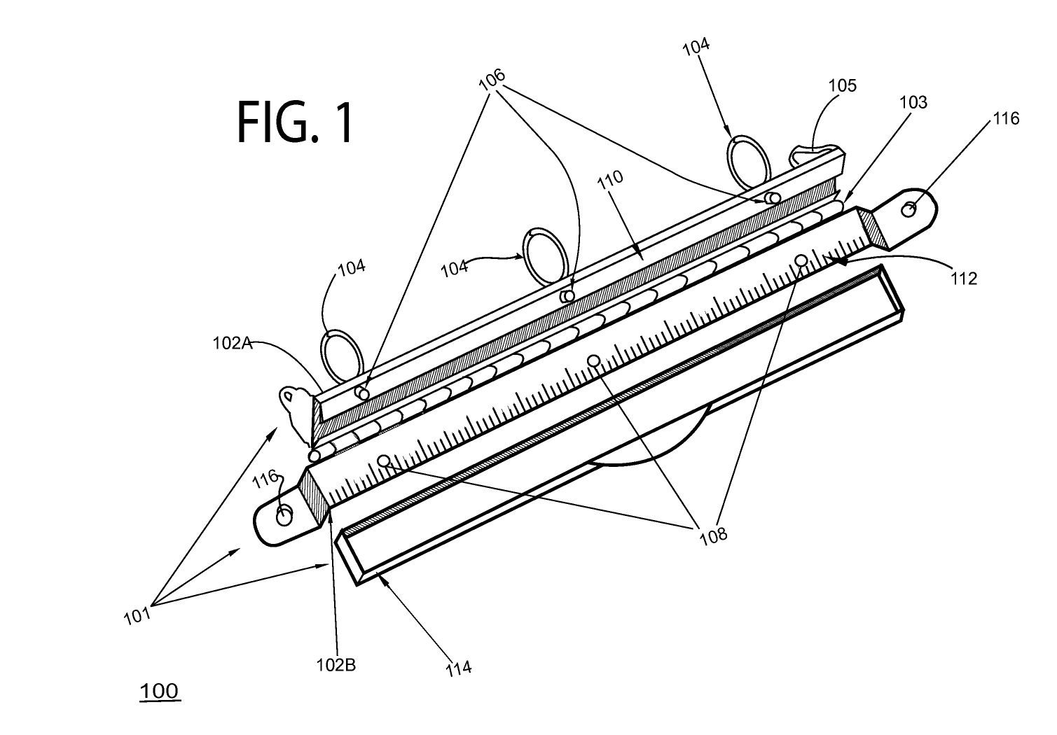

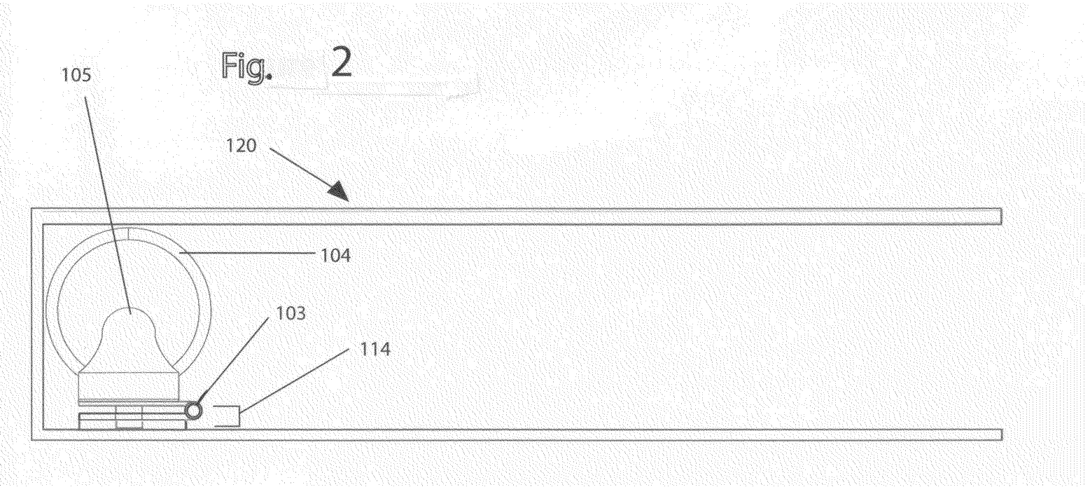

Referring generally to FIGS. 1 and 2, perspective and side views of an example embodiment of a ring binder mechanism and hole-punch assembly 100 according to the present invention is shown. Ring binder mechanism 100, in this example embodiment, includes a binder carriage 101 with a first plate (or carriage frame) 102A. In a related embodiment, the carriage frame and first plate 102A can be a single unit or piece. In this example embodiment, a second plate (or support carriage frame) 102B is coupled in a hinged relationship via a hinge 103 to first plate 102A. In this example embodiment, plate 102A includes a plurality or multiple ring members 104 on the top surface and a set of hole-punch projections 106 underneath that correspond to a set of apertures or holes 108 formed in plate 102B so as to configure a hole-punch assembly 110. In a related embodiment, projections 106 are disposed directly underneath binder carriage 101 so as to eliminate plate 102A. In this example embodiment, punch die projections 106 are aligned with corresponding ring members 106 but can be configured differently to include more or less projections and to be located where desired or needed for the particular application. In this example embodiment, plate 102B is configurable to include a ruler 112 with measurement markings (US or metric) as desired for the particular application. In this example embodiment, a removable tray member 114 is configured to fit or slide underneath plate 102B to collect hole-punches. In a related embodiment, the removable tray member can be excluded to lower product cost. In this example embodiment, plate 102B is affixable to the notebook or binder via rivets 116 (as mounting hardware), thereby enhancing stability for the user of ring binder mechanism 100. In another embodiment, the notebook and paper punch retainer can be molded as one piece thus maintaining low profile of the binder assembly

Optionally, ring binder mechanism 100 is usable for securing papers without a binder or notebook. In this example embodiment, ring binder mechanism 100 is configurable to be attached to different portable binders (such as a snap fit) and is further configurable to include one or more extension tabs adjacent the longitudinal ends of plates 102A and 102B to form a hanging file, thereby allowing the retained papers to be filed in a hanging file cabinet without the need for manila folders. In a related example embodiment, the binder component is fastenable to the ring binder mechanism of the present invention and is designed to slide or be placed in file cabinet storage. It would host grooves that would match guides in a file cabinet. The ring binder-puncher mechanism of the present invention could be later united to the notebook when portability of the file/papers is needed. In yet another related embodiment, notebook is configurable with vents and special covering to serve as a stable lap top computer stand.

In the above referenced example embodiment, the hole-punch preparation is achieved by placing a standard letter sized (8½″ by 11) paper, aligned with ruler 112, and then the hole-punch operation is executed by pressing (or closing) in a cantilever motion plate 102A downward towards plate 102B to closed or locked position which results in the punch die projection(s) cutting through an aligned sheet or sheets of paper, thus producing the multiple hole punch. The operator simply opens ring members 104 (or split rings) via tabs 105 of binder carriage 101 and inserts the punched paper into the binder rings in a standard fashion. In this example embodiment, plate 102A (or movable carriage) is returned to a closed position with plate 102B and held in place (locked) by the seating of punch die projections 106 into corresponding die receptacle apertures or holes 108. In a related embodiment, an additional clamp or clasp can be included to retain plates 102A and 102B in a locked position. In a related embodiment, ring binder mechanism 100 has extended surface tabs that extend out to serve as designated pushing areas for the user's thumbs to make it easier to push projections 106 downward to pierce the paper. In yet another related embodiment, ring binder mechanism 100 is configured to create the punch is sliding back and forth or pulling the unit straight up (thereby eliminating the hinge between plates 102A and 102B altogether and the unit just snaps closed together when the hole punching operation is complete). In yet another related embodiment, projections 106 and apertures 108 are reversible so as to have projections 106 on the bottom (or plate 102B) and have them pierce the paper from the bottom through apertures 108 on the top (or plate 102A).

Referring further to FIG. 2, ring binder mechanism 100 is attached to a notebook or binder 120. The optional removable tray 114 is also shown. One of the advantages of the various embodiments of the present invention is that the ring binder mechanism provides a low profile and is retrofitable with the form factor of multiple-ring binders or notebooks currently on the market. In another example embodiment, tray 114 provides additional stability to binder 120 as well and is moldable right into the notebook (e.g., plastic injection molding) with a side opening (or slots with or without sliding openings) that opens and shuts to allow the hole punches to be emptied. In a related embodiment, tray 114 is permanently closed bin as it may never have to be opened for paper punches to come out as the hole-punch capability might not be used enough to require emptying. In yet another related embodiment, tray 114 provides support for the puncher assembly of the present invention to help with the downward pressure to create the hole-punch.

In another example embodiment of the invention disclosed herein, the ring binder mechanism 100 is made of a relatively rigid injection-molded plastic such as general purpose styrene and ABS or traditional steel or, ferrous materials, most commonly used in today's binders. In a related embodiment, the ring binder mechanism of the present invention is formed of certain plastic compounds forming a continuum capable of multiple open/close operations by simply flexing the seam, acting as a hinge function (e.g., plate 102A and 102B are a single plate of plastic with a plastic “hinge” therebetween). As in the case of the traditional metal hinge, the punch die are again embedded in the underside of the plastic carriage, positioned directly beneath the rings, which can also be made of plastic and are clipped or can clasp to the plastic carriage via a T-slot in the carriage and a T-tip on one or more (plastic) ring members 104.

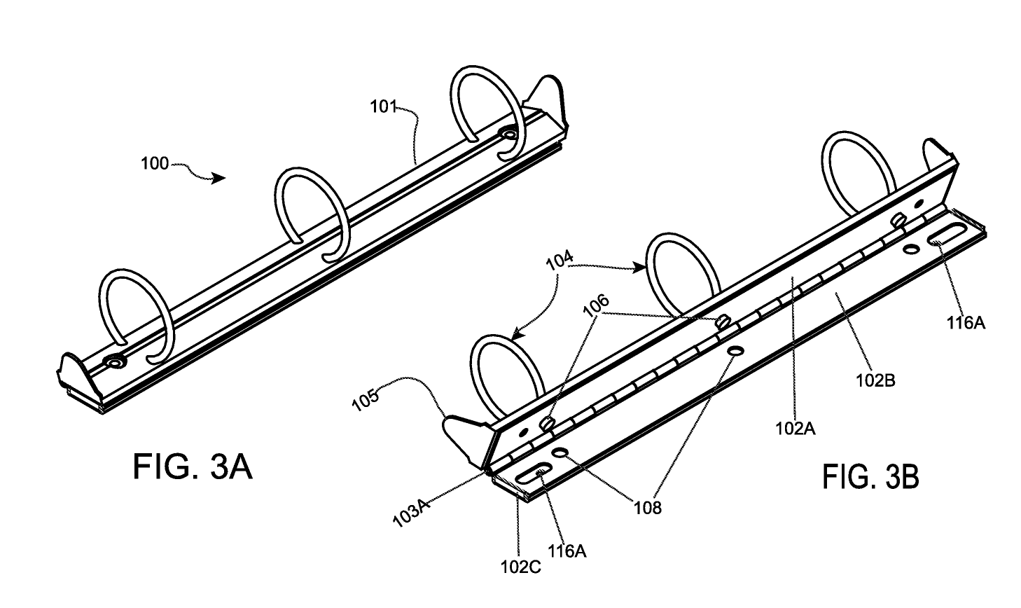

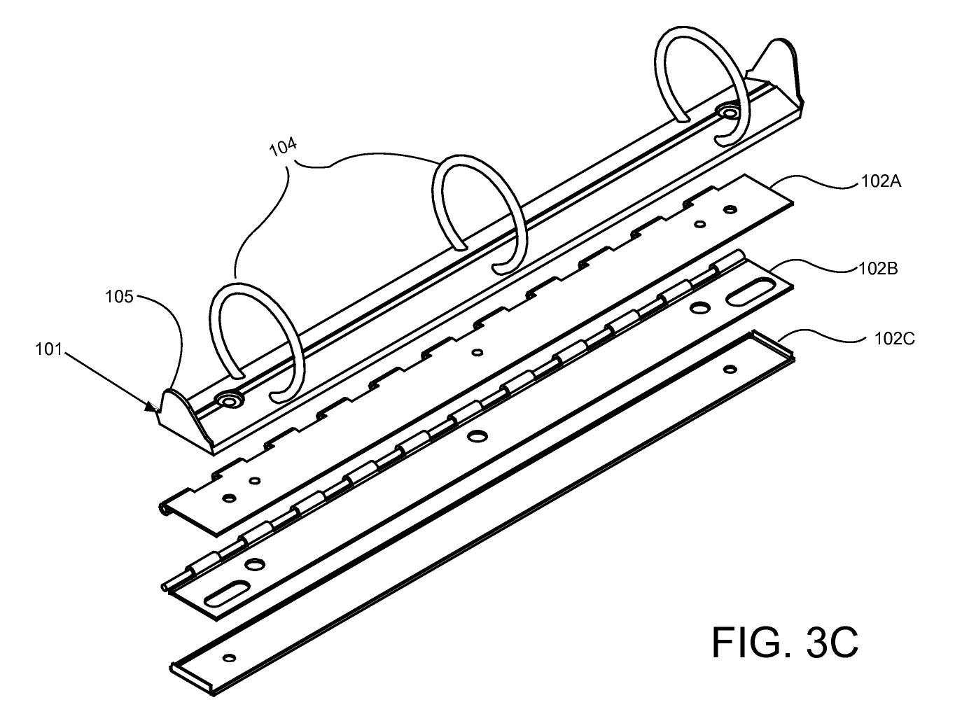

Referring now to FIGS. 3A through 3C, there is shown open and closed perspective views of ring binder mechanism 100 opening lengthwise along a hinged binder frame illustrating the hole-punch feature. Referring specifically to FIG. 3C, there is shown an exploded, perspective view of the binder mechanism of FIG. 3B. In this example embodiment, binder carriage 101, having carriage tabs 105 for opening ring members 104, is a separate member but adhered to plate 102A′ which in turn coupled to plate 102B′ via hinge 103. Although not clearly shown in FIG. 3B, a hinge pin 103A holds plates 102A′ and 102B′ in the hinge relationship. Hole punch projections 106 are disposed on plate 102A′ underneath binder carriage 101, and under each ring member 104, and are configured to associate with apertures 108 in plate 102B′. A base plate 102C serves to secure mechanism 100 to a notebook binder via a set of rivets 116A (as mounting hardware) or to provide additional stability to mechanism 100 (it is also configurable as a tray to capture hole punches).

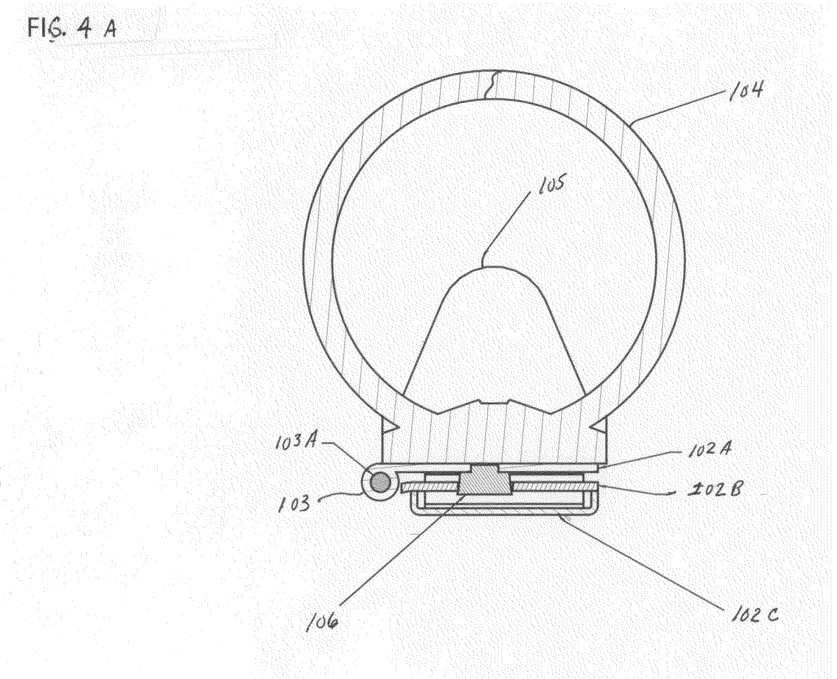

Referring now to FIGS. 4A and 4B, there is shown respective side views of ring member 104 as part of the fully assembled ring binder mechanism 100 as well as an hole-punch portion 400 of ring binder mechanism 100 according to the present invention. Other hole-punch configurations can be incorporated into various embodiments of the present invention are found in example patent numbers U.S. Pat. No. 5,839,843 and U.S. Pat. No. 5,553,958, the teachings of which are incorporated by reference in their entirety. In this example embodiment, hole-punch portion 400 includes a first plate 402A having a projection 406 thereon that corresponds to aperture 408 in second plate 402B that is disposed on a base 402C. Optionally, a tray 414 (removable or permanent) is included below base 402C. Plate 402A and 402B are joined at hinge 403 via a pin 403A to facilitate the cantilever movement of plate 402A.

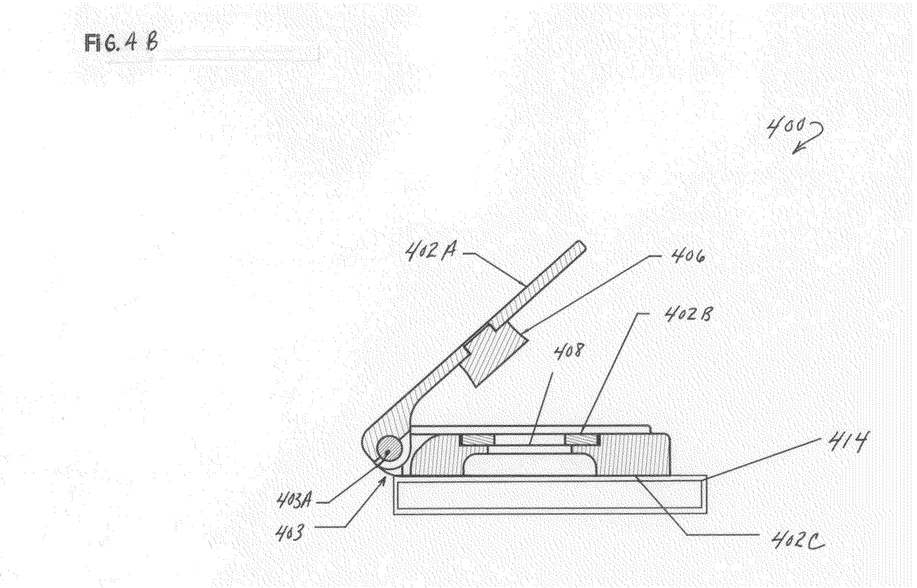

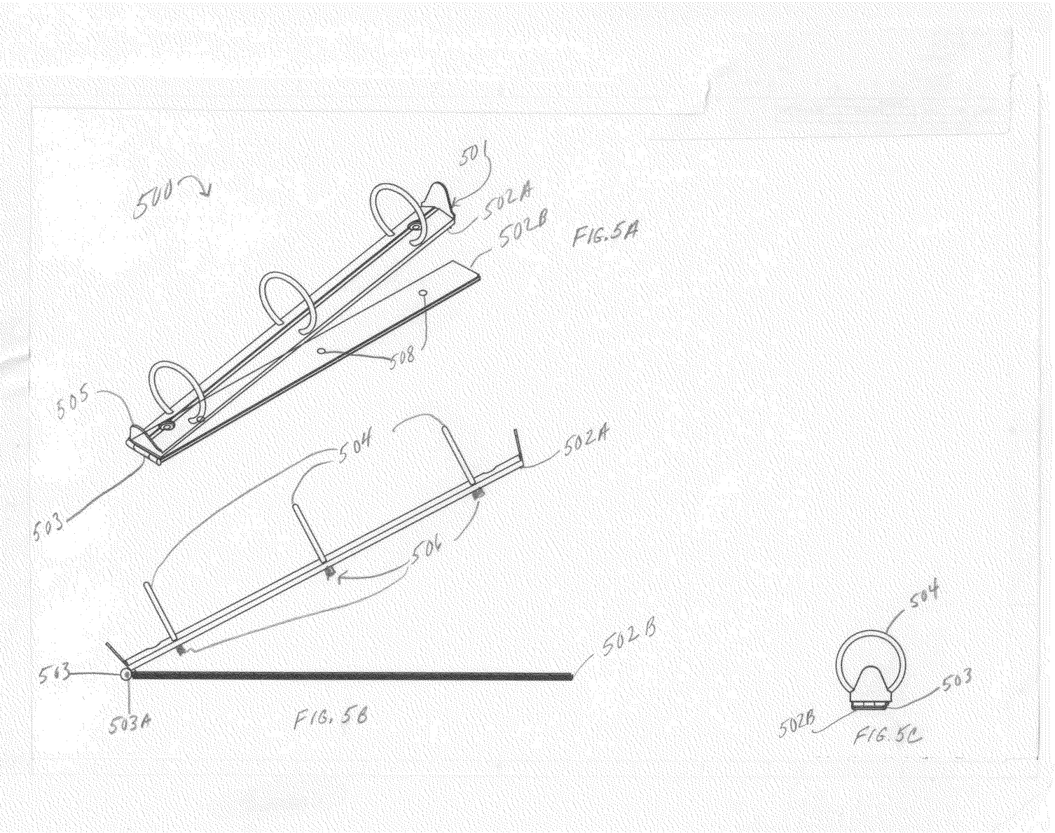

Referring now to FIGS. 5A-5C, there is illustrated perspective, side and end views of another embodiment of the binder mechanism of the present invention using a single-end hinged configuration 500. Ring binder mechanism 500 includes a binder carriage 501, plate 502A and lower plate 502B, a single-end hinge 503 joined via hinge pin 503A, a set of ring members 504 disposed on either carriage 501 or plate 502A and a set of carriage tabs 505. Plate 502A further includes a set of projections 506 adapted to be associated with a set of apertures or holes 508. In related embodiments, the hinge is disposed in a variety of hinge locations on binder spine (or plate) 502A that allow any of four (4) sides to act as the hinge. The hinge may be positioned on either the left, right, top or bottom edge. A snap is incorporated to aid in locking spine 502A to a fixed base 502B to secure the movable spine. Changing the location of the hinge can advantageously be used to accommodate a left hand user vs. right hand user.

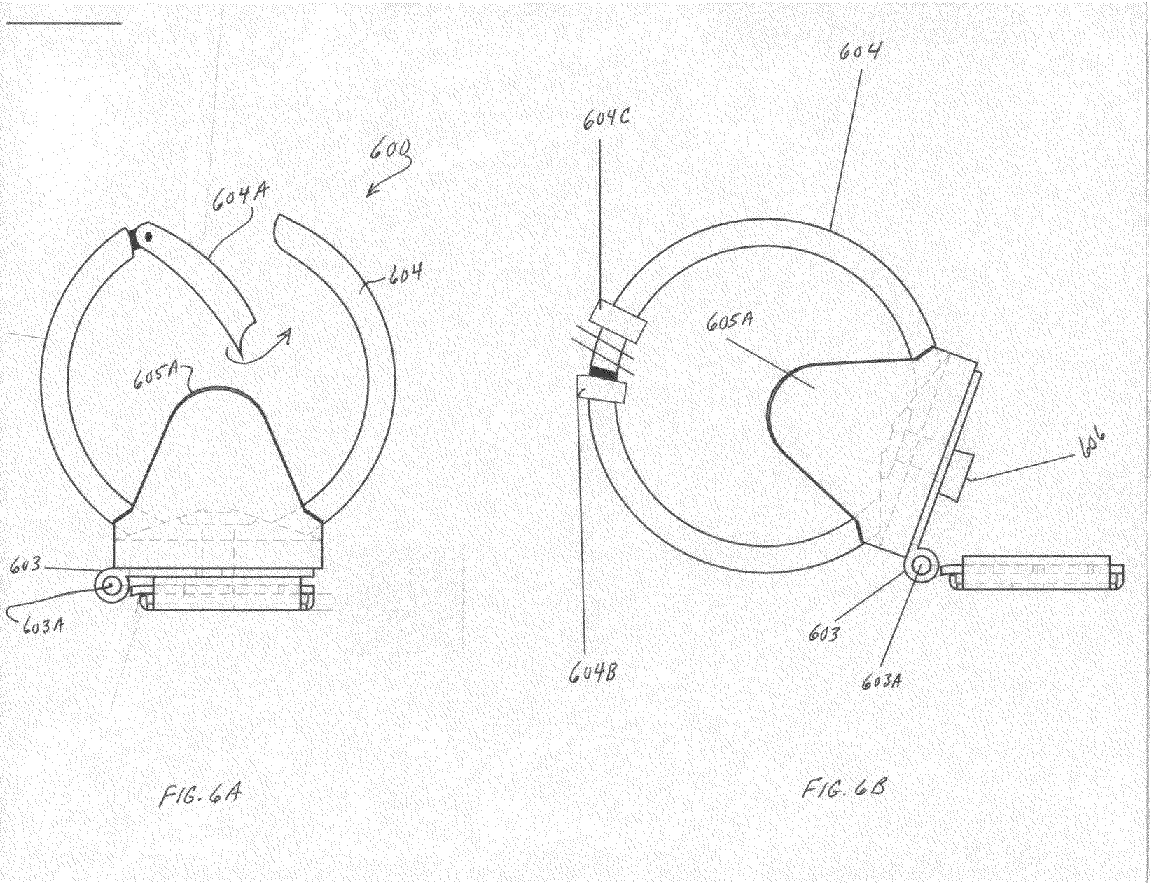

Referring now to FIGS. 6A and 6B, there is illustrated side views of other embodiments of a binder mechanism 600 with hole-punch capabilities of the present invention using different ring member closure mechanisms. In these example embodiments, the complex spring loaded carriage binder and ring member assembly is eliminated and each ring member is opened and closed individually to accept the hole-punched paper. In FIG. 6A, ring member 604 includes a closure lever 604A similar to spring loaded C-clip arrangement (often used in keychains). In FIG. 6B, a gap in ring member 604 is closed to secure the hole-punched paper via a one or two piece male/female barrel closure device or screw-lock (or SurLock) arrangement. In this example embodiment, a male ring closure barrel 604B mates with a corresponding female closure barrel 604C to close ring member 604 closure and retain the hole-punched paper. In a related embodiment, a single closure barrel, male or female can be used where the other end of the open ring member is configured with a male or female end. In a related embodiment, the ring member is a spring clip design such as also used in keychains or paper clips. In yet another related embodiment, closure mechanisms of FIGS. 6A and 6B facilitate the use of a single-ring binder mechanism 600 with a single hole-punch capability to have the smallest, compact paper retaining device where the user desires to store a stack of papers via single punched-hole. FIG. 6B illustrates the single ring binder mechanism 600 in the open position before effecting a hole-punching task.

In related embodiment, one or more ring binder mechanisms 600 are combined in various configurations to accommodate the user needs. For instance, two binder mechanisms 600 can be used for photo albums or small portable notepads. One or more binder mechanisms 600 can be used on a clipboard and in a legal-style folder.

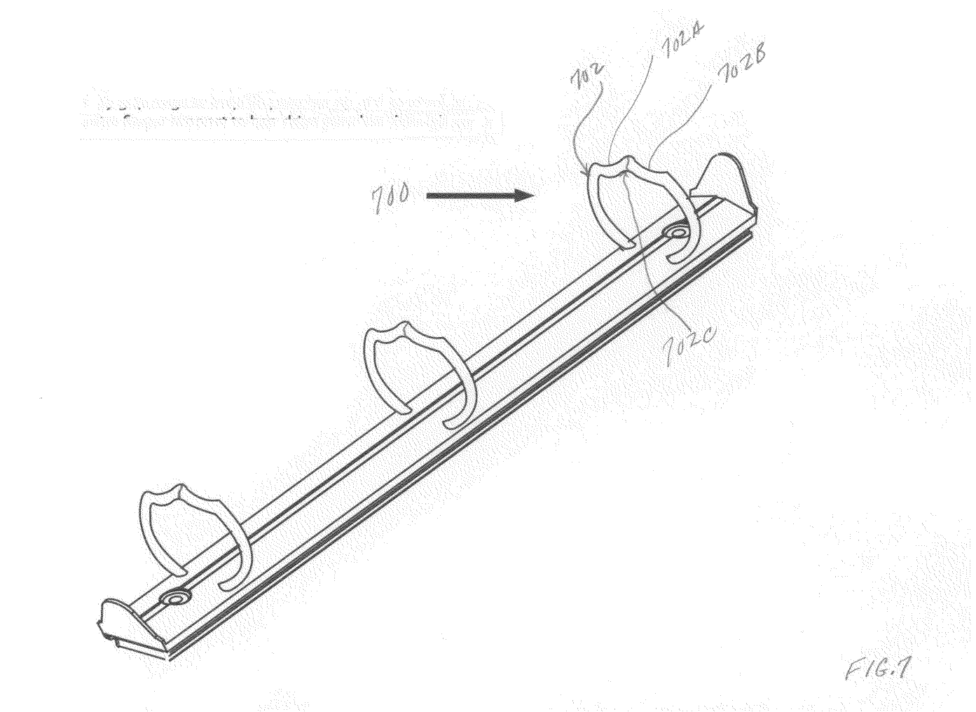

Referring now to FIG. 7, there is shown a ring binder mechanism 700 having a set of rings 702 that are shaped in an “easy-grip” fashion to include at the top of the ring at least 2 curved halves 702A and 702B connecting up at a middle portion 702C to improve gripping of one or more rings 702 (or ring, where it is a single ring embodiment) during a hole punching operation. This example embodiment is applicable to the various hinge embodiments disclosed herein.

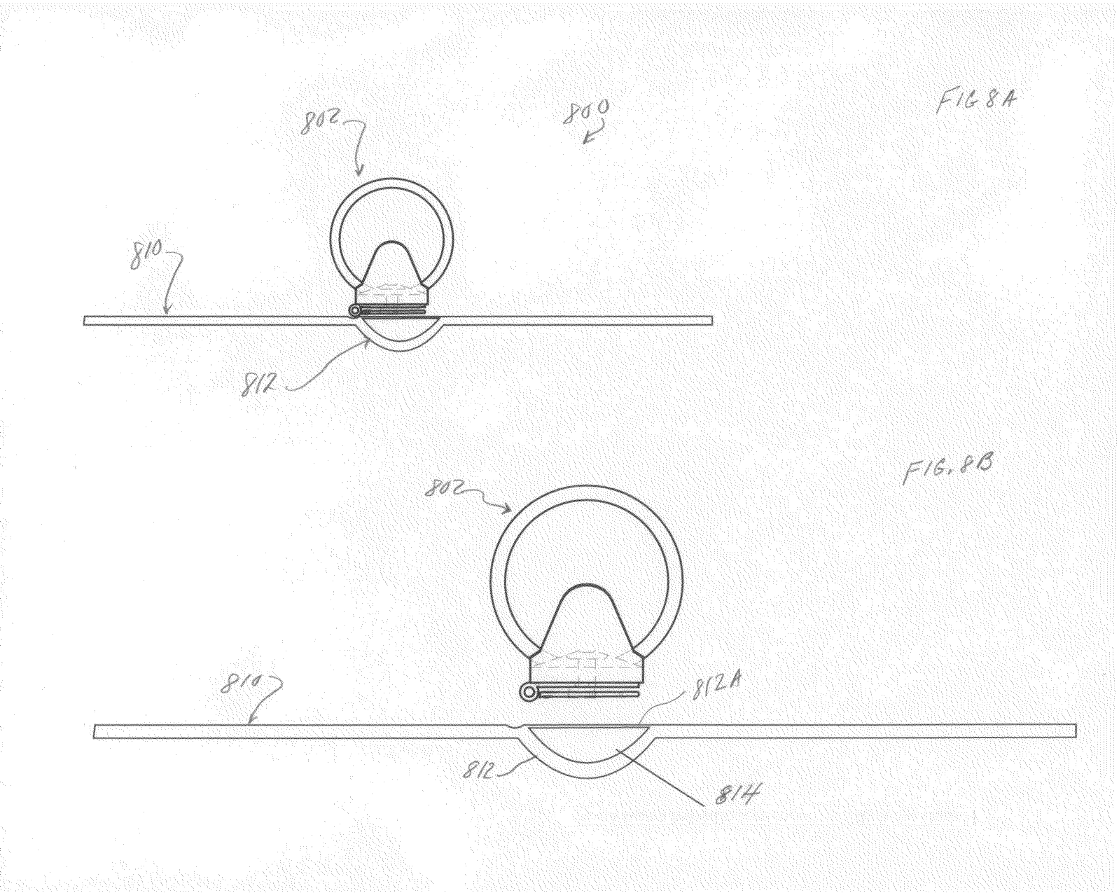

Referring now to FIGS. 8A and 8B, there are shown side views of another embodiment of the binder mechanism assembly 800 of the present invention. In this example embodiment, ring binder mechanism 802 is configured to be disposed in contact with (or attached to) binder 810 at a binder spine 812. FIG. 8B illustrates an exploded view of assembly 800 wherein binder mechanism 802 is detached from a binder spine plate 812A that together with a binder spine 812 form a punch collection cavity 814.

All patents, patent applications, and publications cited herein are hereby incorporated by reference in their entirety as if individually incorporated.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A ring binder mechanism with holepunch assembly, comprising:
a first elongate plate having a top and a bottom surface;
a plurality of ring members disposed on the top surface of the first elongate plate, the ring members configured to be opened and closed;
a plurality of projection members disposed on the bottom surface of the first elongate plate;
a second elongate plate coupled to a portion of the first elongate plate so as to form a hinge therebetween, the second plate having a plurality of holes configured to be aligned with the plurality of projection members in a mating relationship thereby forming the holepunch assembly; and
a housing disposed underneath the second elongate plate.

2. The ring binder mechanism of claim 1, wherein the second plate is adapted to be securely attached to a flat portion of a notebook and the housing is adapted to be secured underneath the second elongate plate.

3. The ring binder mechanism of claim 1, wherein the hinge is formed along an edge lengthwise of the first and second plates.

4. The ring binder mechanism of claim 1, wherein the hinge is formed along an edge widthwise of each of the first and second plates.

5. The ring binder mechanism of claim 1, wherein the hinge comprises a plurality of spaced hinges, said hinges being located on a side edge of the first and second elongate plates.

6. The ring binder mechanism of claim 1, wherein the ring members are configured to be opened and closed individually.

7. The ring binder mechanism of claim 1, further comprising a binder with a binder spine, the binder mechanism adapted to be coupled to the binder spine and configured to be enclosed within the binder.

8. The ring binder mechanism of claim 3, further comprising a clamping member to secure the first and second elongate plates together.

9. The ring binder mechanism of claim 1, wherein the second elongate plate is configured to be secured directly to a binder spine of a binder.

10. The ring binder mechanism of claim 1, wherein the second elongate plate is configured to be a ruler adapted for measuring in desired units.

11. The ring binder mechanism of claim 1, wherein the second elongate plate is configured to be attached to a binder with one or more rivets.

12. The ring binder mechanism of claim 1, wherein the plurality of ring members is selected from the group of ring configurations consisting of an easy grip ring, a C-clip ring, a screw-lock ring, a molded ring and a spring clip ring.

13. The ring binder mechanism of claim 1, wherein the first plate and the second plate are configured from a single piece of material with the hinge being formed therebetween from the same piece of material.

14. The ring binder mechanism of claim 13, wherein the single piece of material further includes the plurality of projections molded on the first plate, the plurality of ring members formed on a top edge of the first plate having a T-shaped or sphere termination, the second plate having the plurality of holes punched therethrough.

15. A ring binder mechanism with holepunch assembly, comprising:
a first elongate plate having a top and a bottom surface;
at least one ring member disposed on the top surface of the first elongate plate, the at least one ring member configured to be opened and closed;
at least one projection member disposed on the bottom surface of the first elongate plate; and
a second elongate plate having at least one hole therethrough, the aperture configured to receive the at least one projection member therethrough, wherein the first plate and the second plate are configured to be joined via the projection member and the aperture to form the holepunch assembly.

16. The ring binder mechanism of claim 15, wherein the at least one ring member is selected from the group of ring configurations consisting of an easy grip ring, a C-clip ring, a screw-lock ring, a molded ring and a spring clip ring.

17. A ring binder mechanism with holepunch assembly, comprising:
a first elongate plate having a top and a bottom surface;
a plurality of ring members disposed on the top surface of the first elongate plate, the ring members configured to be opened and closed;
a plurality of projection members disposed on the bottom surface of the first elongate plate; and
a second elongate plate having a plurality of holes configured to be aligned with the plurality of projection members in a mating relationship thereby forming the holepunch assembly.

18. The ring binder mechanism of claim 17, the second elongate plate coupled to a portion of the first elongate plate so as to form a hinge therebetween.

19. The ring binder mechanism of claim 17, further comprising a housing disposed underneath the second elongate plate.

20. The ring binder mechanism of claim 19, wherein the housing is formed in part by a binder spine that supports the plurality of ring members in a binder.
